(19) United States
(12) Patent Application Publication
(10) Pub. No.: US 2004/0118039 A1
(43) Pub. Date: Jun. 24, 2004

(54) Method and protective cover, e.g., for grass protection, restoration, seed germination

(76) Inventor: Peter Hinsperger, Mississauga (CA)

Correspondence Address: Ian Fincham, McFadden, Fincham, Suite 606, 225 Metcalfe Street, Ottawa, ON, K2P 1P9, CA

(21) Appl. No.: 10/444,948

(22) Filed: May 27, 2003

(30) Foreign Application Priority Data
Dec. 23, 2002 (CA) 2,415,074

(51) Int. Cl. A01G 13/02

(52) U.S. Cl. 47/31.1

(57) ABSTRACT

A protective heat absorbing and heat reflective covering material for turf or lawn use comprising an open mesh weave of scrim material, the mesh having warp and weft strips forming a substantially thin layer having opposed major surfaces, where at least one of the warp or weft strip materials is a heat absorbing or heat reflecting material, and at least one of the major surfaces of the scrim material has a discontinuous coating having heat reflecting or heat absorbing properties opposite to that of the warp and or weft strip, the discontinuous coating thereon at least partially covering the surface.

### FIELD OF THE INVENTION

The present invention relates to a method to protect and to enhance the growth of outdoor grass areas, and in particular to a method and product for covering an area of grass or the like substrate with an improved insulating cover which allows for heat absorption and heat reflection properties to be directed to the substrate thereby optimizing temperature conditions for growing of e.g. plants, grass, etc.

### BACKGROUND OF THE INVENTION

There are various methods and products well known in the art which attempt to protect exterior grass and turf from desiccation, winter kill and the like by covering an area to be protected. Specifically, Canadian Patent No. 1,272, 027 describes a woven insulated cover which is particularly well suited for use in preserving and protecting grassed areas from winter kill. The present invention improves upon the features of the '027 patent in the manner described below.

Also, in the case of gardens such as vegetable gardens, there is a need to maintain higher earth temperatures particularly for over the winter crops, germination of seeds and the like. At present, while there are certain types of air and water permeable products on the market, none of those products are very effective to enhance earth temperatures and promote early development of e.g. seeds or over-winter crops.

### SUMMARY OF THE INVENTION

According to one aspect of the present invention there is provided an improved protective scrim material, suitable for use in the above described fields, having heat reflective properties and heat absorption properties in order to impart improved temperature conditions to the covered surfaces.

According to another aspect of the present invention, there is provided heat reflecting, heat absorbing protective covering material, comprising an open mesh weave of scrim material, the scrim material having warp and weft strips forming a thin layer with opposed major surfaces, at least of one of the warp or weft strips being a heat absorbing or heat reflecting material; one of the major surfaces of the scrim material has a discontinuous coating thereon partially covering the surface; the coating being provided with heat reflecting material or heat absorbing properties opposite to that of the warp or weft strips.

In a preferred embodiment of the present invention, the protective material is a continuous sheet of a one-piece “open” weave thermoplastic scrim material which may be provided with suitable stabilizing additives conventional in the industry as represented by ultraviolet stabilizers, extenders, anti-oxidants and the like.

Desirable properties exhibited by the products of the present invention are that the cover includes heat absorption and heat reflection properties to permit enhanced substrate conditions together with the fact that the product is moisture permeable when subjected to water pressure similar to that encountered during rainfall, or under conditions of watering an area (i.e. with a hose) while at the same time being able to retain moisture beneath the protective cover without permitting the same to substantially evaporate. In a like manner, the product of the present invention permits the passage of atmospheric air under normal atmospheric conditions so that the cover “breathes” but at the same time, prevents abnormal atmospheric conditions e.g. atmospheric wind from penetrating to any extent through the protective cover. This aspect of the present invention is particularly suitable in the application of the protective cover for use as a turf or field cover.

When the protective cover is in use in the above described field, desirably the scrim layer comprises an open-mesh weave of thermoplastic scrim material, the mesh comprising one or more substantially thin layers of intersecting strands of thermoplastic material forming a substantially closed formation when in a lay-flat condition having opposed major surfaces, the mesh having a plurality of slits formed by intersecting strands of the open-mesh weave thereby permitting the passage of moisture therethrough upon moisture pressure against the material. The plastic material forming the strips of said composite can be made of any suitable material such as a polyolefin, the preferred polyolefin being a polyethylene or polypropylene (or a copolymer). The lace coating and the warp and weft strips can be each made of the same or a different polyolefin compatible with the polymer of the other components.

With respect to the above described field, the protective covering material includes one of the warp or weft strips having heat absorptive or heat reflective properties. Also, in some cases, it may be desirable to have both of the warp and weft strips with heat absorptive or heat reflective properties in order to increase the amount of heat absorption or heat reflection of the product. Most preferably, the warp and weft strips form a substantially thin layer with opposed major surfaces. The amount of heat absorption or heat reflection (when only one of the warp or weft strips function to provide the heat absorption or heat reflection characteristics) can also be varied depending on the width of the individual warp and weft strips. For example, if the warp strips have a width twice that of the weft strips, and if only the warp strips are provided with the heat reflective or heat absorptive properties, then the amount of heat absorption or heat reflection will be significantly increased compared to a similar product where the warp and weft strips have a similar width.

Most preferably, only one of either the warp or weft strips has a heat reflective or heat absorptive property, with the other of the strips permitting the passage of light as it is translucent, semi-transparent or clear. This translucent property allows for light to reach the turf beneath the protective cover so as to promote growth thereof.

One of the major surfaces of the scrim has a discontinuous coating thereon, e.g. a lace coating which at least partially covers the surface, where the coating has heat reflecting properties or heat absorbing properties opposite to that of the warp and weft strips. The lace coating is thus either heat absorptive or heat reflective depending on the nature of heat absorption and or heat reflective properties of the warp and weft strips.

The thickness of the scrim material used in the method of the present invention for either of the above fields is not critical per se, as long as the product remains flexible and to the extent that water is generally able to permeate the surface; the thickness can be e.g. from 1 mil to e.g. 30 mils. or more if desired. The lace coating may likewise be relatively thin so that an overall lightweight covering can be obtained. For various types of applications, it may be desirable to provide a border surrounding the sheet material to provide an integral product. Typically, preferred materials for the scrim layer and lace coating are thermoplastic in nature and by way of example such materials may be formed from a polyolefin such as polyethylene, polypropylene, copolymers, etc.

The coating component of the covering material of the present invention is of a discontinuous or intermittent nature, desirably in the form of a lace coating, and which forms an irregular pattern on one surface of the scrim layer. As will be described hereinafter, the lace coating can be in the form of irregular islands of coating with the islands being connected by strands or narrow strips of coating material. This coating tends to stabilize the warp and weft strips of the scrim layer and thus forms an integral product, particularly when the warp and weft strips of the scrim layer are not otherwise adhesively associated with one another. The lace coating may be formed from a heat absorbing material or a material having a heat absorbing component such as coloured material. Desirably, the coating will cover between 5% to 80% of the scrim layer on one face thereof, most desirably 10% to 65% and preferably 15% to 50% of that surface. The coating may be applied to the scrim layer by suitable conventional techniques such as calendering, spraying, co-extrusion, or even adhesively bonded.

With respect to the heat absorbing function of either the lace coating or at least one of the warp or weft strips, such characteristics can be achieved by either selecting a thermoplastic material which has the capability of absorbing heat from the atmosphere (using selected additives in the material) or alternatively, by utilizing a colouring agent of a suitable characteristic which absorbs the energy emitted via the normal spectrum of light waves. Likewise, the other of the lace coating or of the warp/weft strips which is provided with reflective characteristics is produced, for example, by applying a colouring agent to the surface area from the normal light spectrum having heat specular properties such as white, silver, gold, bronze, etc.

In another embodiment of the present invention, there is provided a method of forming a heat absorbing and heat reflective composite layer which comprises the steps of providing an open-mesh weave of scrim material in which the material has warp and weft strips forming a substantially thin layer and having opposed surfaces; wherein at least one of the warp or weft strip materials is of a heat absorbing material or a heat reflecting material, and coating at least one of the surfaces of said scrim material with a coating to at least partially cover the surface, in which the coating has heat reflecting or heat absorbing properties opposite to that of the warp or weft strips.

If desired, one or more reinforcing layers or threads may be included in the product structure where very thin covering products are used. Such a reinforcing layer or threads can strengthen the product as desired, particularly for large products covering large surfaces. For example, depending upon the desired use of the protective cover in either of the above noted fields, such reinforcing layers can be in the form of additional reinforcing scrims incorporated into the material on one or both sides, desirably below the lace coating. Reinforcing techniques are known in various arts; they may be incorporated into the product on an in-line basis when the product is manufactured by extrusion, coating or like techniques. Any added reinforcing layer should not reduce the total slit availability of the material in such a manner as to close off substantially all of the slit apertures between adjacent strands; it may contribute to a reduced slit availability when this is desired to thereby provide different water permeability characteristics for different areas of the woven material.

Additionally, another embodiment of the present invention includes a method for protecting or enhancing turf, lawn or like substrates comprising: applying to a substrate surface a protective heat absorbing and heat reflecting protective covering material, the material comprising an open mesh weave of scrim material, the weave having warp and weft strips forming a substantially thin layer having opposed surfaces, wherein at least one of the warp or weft strip materials is heat absorbing or heat reflecting, and where one of the surfaces of said scrim material has a discontinuous coating thereon at least partially covering that surface and in which the coating has heat reflective or heat absorptive properties opposite to that of the warp or weft strips; the protective covering being applied to a surface with the heat absorption layer facing outwardly and the heat reflective layer being in contact with the substrate surface, and releasably applying (and if desired, securing) the protective layer to the substrate.

As otherwise outlined herein, heat retention or heat absorption properties for the covering materials of the present invention, can also be varied by different means such as using concentrated or strong colours, or by including heat absorption additives in the warp/weft strips or lace coating. Thus, by way of example, reflective or absorptive particles could be included in the lace coating and/or the warp/weft strips to increase the properties desired. In addition, in the case of extruded polymeric materials for use in the lace coating, or the warp/weft strips, a co-extruded product could be employed to vary the amount of heat absorption/heat reflection characteristics of the product. Thus, even transparent, semi-transparent, or translucent strips or lace coating can be employed in which the strips or coating are of a co-extruded nature and in which a second component of the product provides the desired properties.

As otherwise outlined herein, heat retention or heat absorption properties for the covering materials of the present invention, can also be used in various climates and under varying conditions. Thus, depending on its intended application in either of the above described fields, the protective cover and its make-up may vary considerably. For example, a product of the present invention can find use in colder climates by having one component (e.g. the warp/weft strips) with strong heat absorption properties together with the other component (e.g. the lace coating) with strong heat reflection properties whereby maximum amounts of heat can be retained in the substrate as well as be absorbed from the light. When strong heat reflection or heat absorption are desired, both the warp and weft strips can be provided with the desired property; in addition, by varying the amount of coverage formed by the lace coating on one surface of the product, increases or decreases in the light absorption or light reflection can be obtained.

In warmer climates where heat absorption is not of a primary concern, but heat retention is desired (such as due to cooler nights) again the product structure may vary by having, for example, both warp and weft strips functioning as a heat retention layer and by modifying the lace coating to include either lower heat absorption properties (e.g. by reducing the colour intensity) and/or by decreasing the amount of the lace coating. Such a use contemplated by the present example finds particular use as a protective cover for grass or turf areas.

The products of the present invention are particularly suitable for use on lawns, golf greens, or other turf applications where it is desired to control and enhance the ambient temperature of the turf or like surface. By way of example, golf greens frequently employ protective covering layers for wintering purposes; by utilizing the cover of the present invention, not only is moisture permitted to reach the substrate, and be ventilated, but due to the heat reflective layer, heat can be transferred to the substrate particularly for Spring-time use. Likewise the heat temperature of the substrate can be enhanced due to the heat reflective layer of the product and its function of reflecting radiated heat from the substrate back into it. It will be obvious to those skilled in the relevant art that different degrees of heat absorption and heat radiation can be achieved for different purposes in the products of the present invention to permit products to be tailored for different applications and locations. One particular advantage of the present invention is that since only one lace coating is required, there is a savings in material, savings in the time required for producing the product, and costs are reduced.

### BRIEF DESCRIPTION OF THE DRAWINGS

Having thus generally described the present invention, reference will now be made to the accompanying drawings as follows:

FIG. 1 is an elevated perspective view of a product of the present invention, which illustrates one face of the product provided with a lace type coating over the scrim structure;

FIG. 2 is a diagrammatic cross-sectional view of the present invention; and

FIG. 3 is an enlarged bottom view showing the reverse side of the product of FIG. 1, which shows the scrim structure of warp and weft strips.

### DETAILED DESCRIPTION OF THE PREFERRED EMBODIMENTS

The products of the invention are particularly suitable for protecting environmentally sensitive areas, such as turf or grass areas where, for example, selected portions of such turf or grass must be protected. Such areas may include, but are not limited to, athletic fields (such as natural grass baseball or soccer stadiums where the infield is a specially groomed surface), golf courses (where golf greens are maintained to higher standards compared to the balance of the playing area), or other agricultural (e.g. garden) applications. In such areas, diverse types of grass or vegetation may be used compared to adjacent areas, and various types of chemical treatments from fertilizers to herbicides may be used in order to maintain such areas at certain standards.

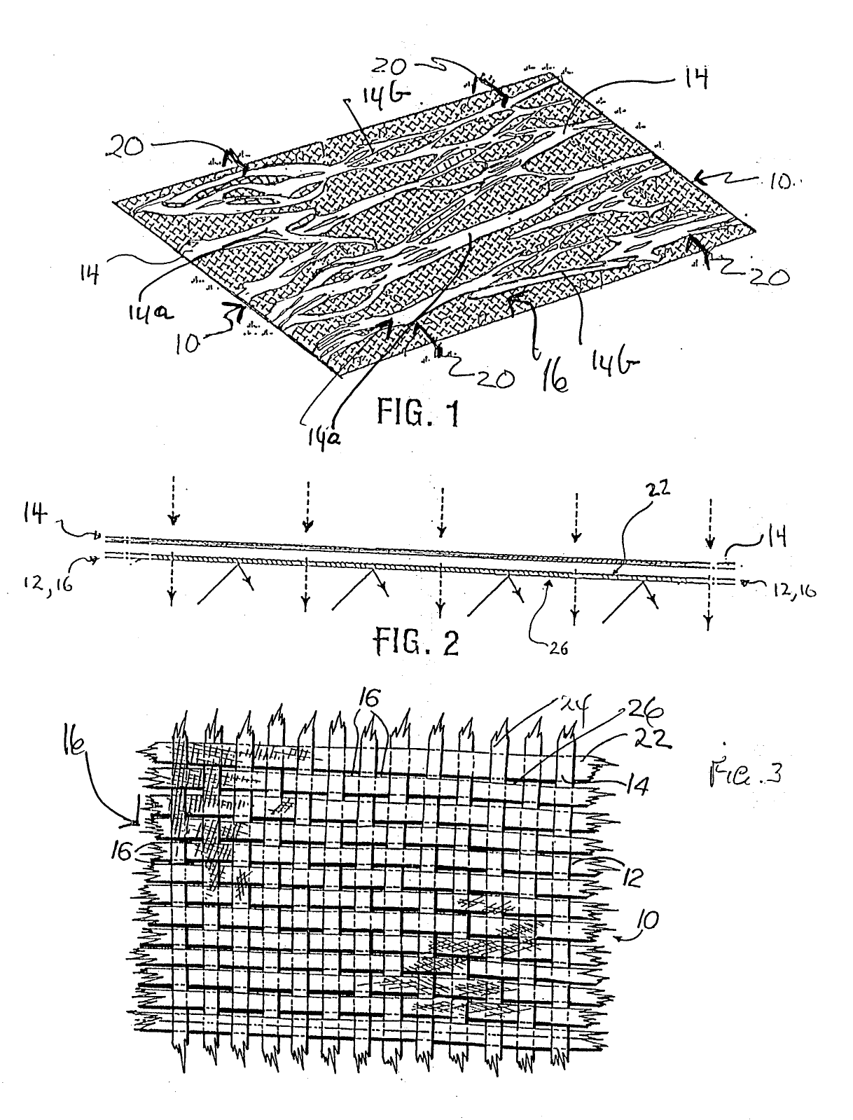

FIG. 1 illustrates a cover (10) according to a preferred embodiment of the present invention in use over an area to be protected, in this case a golf green. As illustrated cover (10) consists structurally of a scrim layer indicated generally by reference numeral (16) with opposed major surfaces (22) and (26), and a discontinuous plastic polymer lace coating (14). Lace coating (14) is located only on one surface (22) and comprises a calendared polymeric material in the form of connected elongated “islands” (14a) of coating material as seen in FIG. 1. Adjacent islands (14a) are interconnected by strands or small lengths of coating material (14b), in a random fashion. These islands (14a) will have varying widths and lengths but in general, the total surface area coverage of the lace coating in the embodiment illustrated is in the range of 15 to 20% of the surface on which it is located. Desirably, the overall cover is lightweight and flexible to allow for easy manipulation of the protective cover (10) over a substrate.

In the present embodiment, the discontinuous coating layer (14), provides a heat absorbing layer for the product. In this case, given the amount of heat absorption generally required for this particular application and given the climate in which the application is located in (with relatively cool evening temperature conditions and warmer daylight temperatures), the amount of heat absorption required is relatively low, but conversely, the amount of heat retention required is significant.

In a preferred embodiment, the heat absorbing material (the lace coating layer (14)) is a polyolefin polymer, provided with a suitable colouring agent for absorption of heat. For example, colours such as green, blue, black, and the like, provide suitable heat absorption properties for the layer (14) absorbing ultraviolet rays from the sun and can be used in the lace coating material.

As illustrated in FIG. 1, cover (10) is maintained or secured in place through suitable securing means, for example a plurality of elongated clips or pins (20). Pins (20) are spaced apart peripherally about the cover (10) and are adapted to releasably secure the cover to the surface of the green. Pins (20) would include a suitable catch, for example, a hook which could be driven into the substrate. The other end of the pin (20) may also be provided with a hook to penetrate the cover (10) and likewise be inserted into the substrate. Other securing means such as hooks, wire stakes, etc. may alternatively be used to releasably secure the cover (10). Alternatively, cover (10) may include other means (not shown) such as reinforced apertures (eyelets) which may also be used in combination with a pin (20).

FIG. 2 is a schematic representation of a cross-sectional view of the protective cover (10) when in use over a golf green. As will be seen, the heat reflection surface constituted by the warp and/or weft strips (22) and (24), as described above with respect to FIG. 3, and which are provided with heat reflecting properties, face the substrate. Due to the relatively tight knit weave of the warp and weft strips forming the scrim material, even with slits (26), much of the heat normally removed during the evening will be retained in the substrate.

FIG. 3 shows schematically the reverse face of the product of FIG. 1 and illustrates the structure of the warp and weft strips forming the scrim layer. For ease of reference and clarity, the lace coating on the other surface of the product is not shown (the lace coating, of course, would otherwise cover some of the slits between the warp and weft strips described hereinafter). In greater detail, as illustrated in this enlarged figure, there are provided a plurality of spaced apart weft strips (22) and warp strips (24) which are interwoven to form the scrim layer (16). The intersecting warp and weft strips can be slightly spaced apart, if desired, to provide slits 26 in the scrim layer, which slits (26) can be varied as to the degree of openness by controlling the tightness of the “weave” of the scrim layer. In the particular version shown, the slits (26) may constitute anywhere from 1% to 15% or so of the total surface area of that face of the scrim layer, so to permit water to penetrate the product and provide moisture to the substrate layer. It will be appreciated that weft and warp strips (22) and (24) need not be spaced apart per se in order to permit water penetration. This is due to the fact that such warp and weft strips, even though generally retained in place by the lace coating, are not otherwise secured to each other and thus even slight moisture pressure can penetrate between intersecting warp and weft strips.

The individual weft and warp strips (22) and (24) can vary in width considerably, as noted previously. In the arrangement illustrated in FIG. 3, the warp and weft strips are generally of the same dimension(s) width wise, but as noted previously this can be varied so that one has a larger width than the other, depending on the ultimate heat reflective or heat absorptive properties desired in a product for any given application. Typically, the width of the warp and weft strips can range from about 1/8th of an inch to 1 inch or more. For most general applications, these strips will have a width in the range from 1/4 inch to 1/2 inch.

In the embodiment shown in FIG. 3, one of the warp and weft strips or both are provided with heat reflective components (such as a colouring agent being included in the warp/weft strips), the other is transparent. In this manner, the product as shown in FIG. 1 will include a heat reflective layer in contact with the substrate surface and will reflect radiated heat from the substrate surface back into the substrate.

In a preferred embodiment, as illustrated in FIGS. 1, 2 or 3, the protective cover (10) includes a discontinuous lace coating (14), having warp and weft strips (22,24) interwoven to form a scrim layer generally indicated by reference numeral (16). In such a preferred embodiment, the cover 10 includes heat absorptive properties in only one of the warp or weft strips (22, 24). The other of the warp or weft strips having neither heat reflective or heat absorptive properties is clear, in other words the strip material may be translucent or transparent. Such transparent properties thereof are adapted to allow light to pass through the transparent strip(s) to enable the turf or grass area there beneath to grow or otherwise propagate.

If desired, heat reflective material may be included in the discontinuous lace coating (14) to reflect absorbed heat, from the appropriate warp or weft strip, to be re-directed into or away from the protected turf (dependent upon the desired use of the protective cover 10).

The above embodiments are for illustrative purposes only, and as such various modifications are possible without departing from the scope and spirit of the invention.

I claim:

1. A heat reflecting, heat absorbing protective covering material, comprising:
an open mesh weave of scrim material, said scrim material having warp and weft strips forming a thin layer with opposed major surfaces, at least of one of said warp or weft strips having heat absorbing or heat reflecting properties, and at least a portion of said warp and weft strips having sufficient translucent characteristics to permit the passage of light therethrough, and
one of said major surfaces of said scrim material having a discontinuous coating thereon partially covering said surface, said coating having heat reflecting or heat absorbing properties opposite to that of said warp or weft strips.

2. A heat reflecting, heat absorbing covering material according to claim 1, wherein at least one of said warp and weft strips have heat absorbing properties, said coating having heat reflective properties.

3. A heat reflecting, heat absorbing covering material according to claim 1, wherein at least one of said weft and warp strips have heat reflecting properties and said coating having heat absorbing properties.

4. A heat reflecting, heat absorbing covering material according to claim 1, wherein said coating forms a lace coating on said one surface.

5. A heat reflecting, heat absorbing covering material according to claim 1, wherein said warp and weft strips are of polymeric material.

6. A heat reflecting, heat absorbing covering material according to claim 5, wherein said warp strips are made of a first polymeric material, and said weft strips are made of a second polymeric material different than that of said warp strips.

7. A heat reflecting, heat absorbing covering material according to claim 2, wherein said warp strips are coloured to absorb light in a defined light wavelength to provide heat absorbing properties thereto.

8. A heat reflecting, heat absorbing covering material according to claim 7, wherein warp strips have a colour with a light wavelength characteristic to provide heat reflecting properties.

9. A heat reflecting, heat absorbing covering material according to claim 8, wherein said strips are made of a polyolefin.

10. A heat reflecting, heat absorbing covering material according to claim 9, wherein said polyolefin is a polyethylene and said coating is a polyolefin compatible with said polyethylene.

11. A heat reflecting, heat absorbing covering material according to claim 10, wherein said coating includes a colouring agent providing heat absorption properties to said coating.

12. A heat reflecting, heat absorbing covering material according to claim 11, wherein said colouring agent is green, blue, brown or black.

13. A heat reflecting, heat absorbing covering material according to claim 10, wherein said coating includes a colouring agent providing heat reflective properties to said coating.

14. A heat reflecting, heat absorbing covering material according to claim 13, wherein said colouring agent is silver, gold or bronze.

15. A heat reflecting, heat absorbing covering material according to claim 1, wherein said coating is secured to said surface.

16. A heat reflecting, heat absorbing covering material according to claim 1, wherein said open mesh weave includes openings to allow water to permeate therethrough.

17. A heat reflecting, heat absorbing covering material according to claim 15, wherein said coating on each surface of said open mesh weave amounts to a total of 5% to 80% of the combined total surface area of both faces.

18. A method of forming a heat absorbing and heat reflective covering material, comprising the steps of:
providing a length of open mesh weave covering material, said mesh including warp and weft strips forming a thin layer with opposed major surfaces, wherein at least of one of said warp or weft strips has heat absorbing or heat reflecting properties;
and applying a discontinuous coating to one of said surfaces of said covering material whereby said coating at least partially covers said surface; said coating having heat absorbing or heat reflecting properties opposite to said warp or weft strips.

19. A method of protecting or enhancing turf, lawns, gardens or like substrates comprising applying to the substrate the covering material of claim 1 in which the heat reflective portion of the material is in facing relationship or in contact with the substrate.
